(19) United States
(12) Patent Application Publication
(10) Pub. No.: US 2017/0227351 A1
(43) Pub. Date: Aug. 10, 2017

(54) System and Method for Detection, Characterization, and Imaging of a Stellar Occultation

(71) Applicants: David C. Hyland, College Station, TX (US); Haithem A. Altwaijry, Riyadh (SA)

(72) Inventors: David C. Hyland, College Station, TX (US); Haithem A. Altwaijry, Riyadh (SA)

(21) Appl. No.: 15/502,402

(22) PCT Filed: Aug. 7, 2015
(86) PCT No.: PCT/US2015/044197

§ 371 Date: Feb. 7, 2017

Related U.S. Application Data
(60) Provisional application No. 62/034,517, filed on Aug. 7, 2014.

(51) Int. Cl. G01B 9/06; G01P 15/00; G01C 21/02; G01P 13/00

(52) U.S. Cl. CPC G01B 9/06; G01P 13/00; G01P 15/00; G01C 21/02

(57) ABSTRACT

An asteroid characterization and imaging system comprising at least one light collecting aperture positioned to collect intensity time history data and a data analysis unit configured to detect an occultation event and process said intensity time history data. Embodiments according to the present invention include a method of detecting, characterizing and imaging a near-Earth object comprising collecting intensity time history data by at least one light collecting aperture positioned to observe a star, detecting a stellar occultation event, recording said intensity time history data, processing said intensity time history data, predicting at least one of a set of object characteristics, and imaging said near-Earth celestial object.

### CROSS-REFERENCE TO RELATED APPLICATIONS

The present application claims the benefit of PCT Application no PCT/US2015/044197 filed on Aug. 7, 2015 and provisional application, No. 62/034,517 filed Aug. 7, 2014, which is incorporated herein by reference.

### FIELD OF THE INVENTION

The present invention generally relates to space research, and in particular, a system and method of asteroid detection, characterization, and imaging.

### BACKGROUND INFORMATION

Near-Earth asteroids pose a potential danger to Earth based on the serious damage they cause upon planetary impact. Asteroid collisions, such as the Chicxulub asteroid, can transmit an energy impact that is nearly 2 million times more powerful than the most powerful man-made explosive and can cause mass-extinction events. The secondary effects of an asteroid impact include global firestorms, altered climate, megatsunamis, earthquakes, volcanic eruptions, and acid rain. The Chicxulub asteroid is cited as the main cause of the Cretaceous-Paleogene mass extinction event that eradicated numerous animal and plant groups, including non-avian dinosaurs.

While the Chicxulub asteroid was a larger asteroid, 10 km in diameter, even smaller asteroids can wreak significant damage. The Chelyabinsk meteor was caused by a near-Earth asteroid that exploded in the air over Chelyabink Oblast. The meteor was merely 20 meters in diameter and yet caused a shockwave, injured 1,500 people who needed medical attention, damaged 7,200 buildings in six cities, and produced a hot cloud of dust and gas. It is estimated that the total kinetic energy before atmospheric impact was 20-30 times more than the energy that was released in the Hiroshima atomic bomb. The Chelyabinsk meteor was undetected before entering Earth's atmosphere and caused this level of damage without direct impact on the Earth's surface. It is therefore important to be able to accurately detect, characterize, and image near-Earth asteroids.

One way to observe asteroids is by using stellar occultation. This occurs when a star is hidden by an object such as an asteroid, moon, or planet that is passing between the observer and the star. Most conventional stellar occultation methods require the use of a telescope to measure the size and position of an asteroid and while many asteroids may be observed in this manner, these conventional methods are not effective in observing smaller near-Earth asteroids, like the Chelyabinsk meteor, that can still create serious damage. Furthermore, in conventional occultation methods many observers are needed to simultaneously observe the asteroid, noting the times that the asteroid blocks the star and when the star reappears, in order to accurately characterize it. By processing this data, observers are able to draw a set of parallel lines across a shadow region to determine the asteroid's size and shape.

It is estimated that only 1% of the near-Earth asteroids in the 40-140 meter size range thought to exist have been detected leaving about 285,000 near-Earth asteroids as unknown. Many of these objects are too small and distant to cast the sharply defined shadows required for conventional occultation methods thus making the observation, characterization and imaging of these smaller asteroids improbable if not impossible. Conventional methodologies of stellar occultation are also cost-prohibitive requiring sophisticated equipment and a coordinated team of observers to record data.

### SUMMARY OF THE INVENTION

In accordance with one aspect of the present invention, a method of characterizing a near-Earth object includes collecting intensity time history data by at least one light collecting aperture positioned to observe a star, detecting a stellar occultation event, recording the intensity time history data, processing the intensity time history data, predicting at least one of a set of near-Earth object characteristics, and imaging the near-Earth celestial object. In accordance with at least one embodiment of the invention an asteroid characterization and imaging system comprising at least one light collecting aperture positioned to collect intensity time history data and a data analysis unit configured to detect an occultation event and process the intensity time history data. In one or more embodiments of the invention the intensity time history data represents light reaching the light collecting aperture from the star as a function of time. In one or more embodiments of the invention, observations made during a stellar occultation by an asteroid include determination of the asteroid's size, calculation of the distance between the light collecting aperture and the asteroid, prediction of trajectory, calculation of the asteroid's velocity, and imaging of the asteroid. In one or more embodiments of the invention, the image of the asteroid is derived by applying a shadow function, phase retrieval algorithm, and silhouette function to the intensity time history data.

### BRIEF DESCRIPTION OF THE DRAWINGS

These and other features and advantages of the present invention will be better understood by reading the following Detailed Description, taken together with the Drawings wherein:

FIG. 1 is an elevated system view of an embodiment of the invention exemplifying asteroid occultation detection and characterization system.

FIG. 2 is a detailed view illustrating an alternate embodiment of the present invention.

FIG. 3 is a flow chart of the methodology of an embodiment of the present invention.

FIG. 4 is a detailed view of the imaging module according to an embodiment of the present invention.

### DETAILED DESCRIPTION OF THE PREFERRED EMBODIMENTS

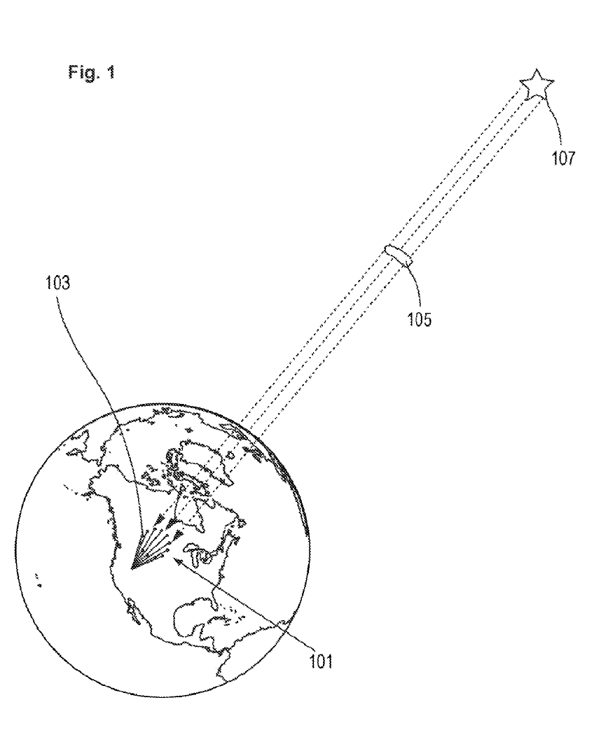

The embodiment of FIG. 1 provides an elevated system view exemplifying asteroid occultation detection and characterization in accordance with an embodiment of the invention. An occultation occurs where a celestial object is hidden by another intervening celestial object passing between the first object and the observer. There are many types of occultation including occultation by moons, occultation by planets, and occultation by asteroids. In the stellar occultation by an asteroid, a star is obscured from the view point of the observer by an asteroid. This happens because the asteroid's trajectory passes in front of the star, temporarily blocking its light from the observer's view.

In accordance with one embodiment of the invention, observations made during a stellar occultation by an asteroid include detection of the asteroid, determination of the asteroid's size and shape, imaging of the asteroid, and prediction of trajectory. These characteristics are important to observe because they allow identification of asteroids or any other celestial object, especially near-Earth objects. If the orbit of a near-Earth object crosses Earth's orbit, the resulting impact event could be catastrophic. Therefore detection, characterization and identification of orbital paths of near-Earth objects like near-Earth asteroids may allow prediction of objects that may pose a danger to the Earth and the magnitude that that danger. Once identified and characterized, these near-Earth objects may, in the future, be mined for mineral resources.

Known methods allow detection of large near-Earth objects, between 10,000 meters and 100,000 meters, which cast a sharp shadow when occulting. These near-Earth objects are within the radiative near-field or Fresnel zone, with Freznel number>1. However, smaller near-Earth objects such as those with diameters between 40 meters and 140 meters do not create these defined shadows with occulting a star. These smaller near-Earth objects have shadows near or within the far field or Fraunhofer region from a distance of astronomical unit (1 AU). Therefore, known methods cannot efficiently detect and characterize these types of objects.

In one embodiment of the invention, shown in FIG. 1, an array 101 of light collecting apertures 103 are positioned, each with its plane normal to the line of sight to a star 107. In this embodiment, the array 101 is a circular arrangement where the light collecting apertures 103 are evenly spaced 30 degrees apart along the circumference of a circle; however the array 101 may take on any general arrangement of the light collecting apertures 103. Additionally, this embodiment illustrates twelve (12) light collecting apertures positioned in the array though the array may have any number of apertures.

According to this embodiment of the invention, the star 107 is being occulted by an asteroid 105. Each of the light collecting apertures 103 continuously records intensity time history data. This intensity time history data represents the intensity of light reaching the light collecting aperture from the star as a function of time. By continuously recording the intensity of light from the star, the light collecting apertures measure the relative intensities before, during and after the occultation of the star. In an embodiment of the invention, light collecting aperture includes a reasonably high bandwidth, at least 10 MHz, Avalanche Photodiode, run in Geiger mode, or a high bandwidth, high sensitivity photomultiplier to measure the light intensity. In this embodiment, the light is passed through a band-limited filter with center at 0.5μ wavelength before its intensity is recorded. The intensity time history data is communicated to a receiving station 109. The receiving station 109 collects the recorded intensity time history data to characterize, image and track the asteroid 105.

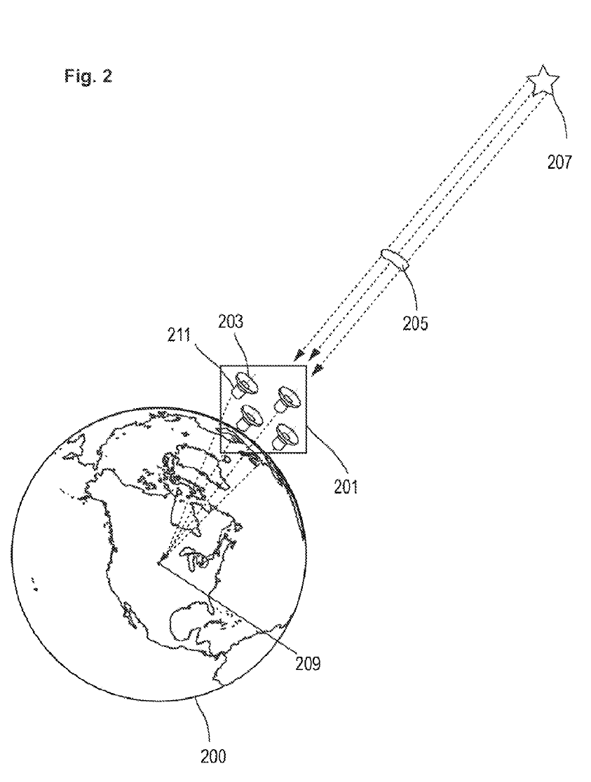

A second embodiment of the present invention, shown in FIG. 2, illustrates a telescope, or other orbital light-receiving aperture with a photo intensity sensor and memory, as the light collecting aperture. Earth based light collecting apertures are restricted to collecting intensity time history data during night hours and preferably when the skies are clear. In this case, the telescope may collect intensity time history data without time and weather constraints.

FIG. 2 shows telescopes 203 positioned in geosynchronous orbit around Earth 200. While this embodiment depicts the telescopes 203 in orbit around Earth 200, the telescopes 203 or other light collecting apertures may be positioned anywhere in space where they may capture stellar occultation events. The telescopes 203 are positioned in an array 201 and are focused on a star 207 that is occulted by an asteroid 205. Each of the telescopes 203 in the array 201 is equipped with a photo intensity detector 211 and records intensity time history data while the asteroid passes between the array and the star. The intensity time history data is communicated to a receiving station 209 on Earth where it is used to characterize, image, and track the asteroid 205.

While FIG. 2 shows that the receiving station 209 is located on Earth 200, in another embodiment of the invention the receiving station 209 may be on a space station, a satellite, a cubesat, a space outpost, space colony, on the Moon, or on another planet. In another embodiment of the invention, the individual telescopes 203 or other light collecting aperture communicate the intensity time history data to each other prior to transmitting to the receiving station 209.

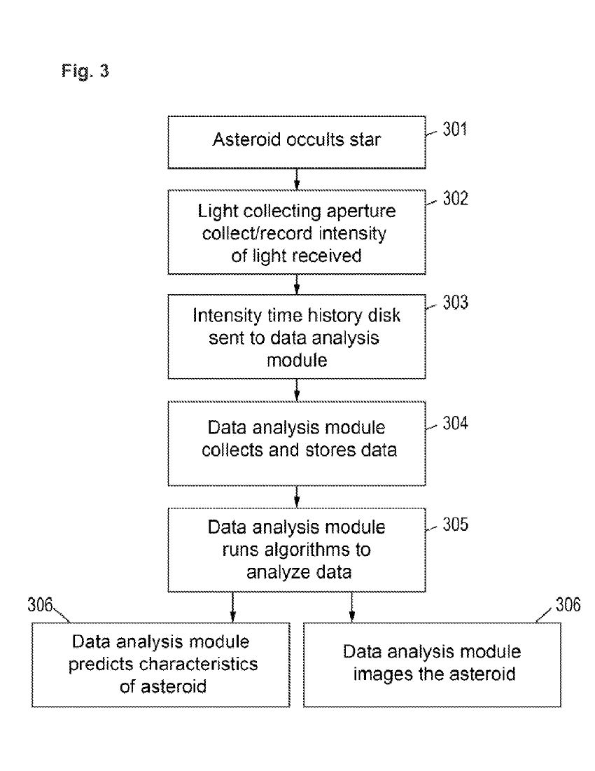

FIG. 3 is a flow chart of the methodology of an embodiment of the present invention. In this embodiment, an asteroid occults a star causing its shadow to pass over the plane occupied by the array 301. The x and y axes define the local coordinate system of the array. A basic assumption here is that the array diameter encompasses most of the cross-section of the territory swept through by the asteroid shadow. Each light collecting aperture continuously collects and records the intensity of the light it receives as a function of time 302. This data of the intensity of light as a function of time is called intensity time history data. Since the intensity of the star before occultation is measured, the intensity time history data comprises the time histories of the intensities normalized by the non-occulted stellar intensity as well as the time history of the intensities during the stellar occultation. The intensity time history data is wirelessly sent to a receiving station 303 where it is collected and stored by a data analysis module at the receiving station 304. The data analysis module analyzes the intensity time history data to characterize and image the asteroid by running several calculations and algorithms 305. In this embodiment, these algorithms are used to produce a shadow function on the plane normal to the line-of-sight at the location of the array. This shadow function represents a pattern of intensity. From the shadow function and other analysis performed by the data analysis module, the asteroid's characteristics are determined and a sharp silhouette image of the asteroid is created 306.

As in FIG. 3, the intensity time history data may be sent wirelessly or through a wired connection to the receiving station. In an embodiment of the invention, one or more light collecting apertures may act as a receiving station such that the intensity time history data is communicated to at least one light collecting aperture from the other light collecting apertures where it is used to characterize and image the asteroid. In another embodiment of the invention, each light collecting aperture sends the intensity time history data to the others where they collectively process the data to characterize the asteroid. In this embodiment of the invention, the intensity time history data is sent upon completion of a stellar occultation event. In an alternate embodiment of the invention, the receiving station is continuously transmitting intensity time history data, not distinguishing whether a stellar occultation event has occurred.

In one or more embodiments of the invention, the light collecting apertures may send a signal to the receiving station when a stellar occultation is detected prior to sending the intensity time history data. In an embodiment of the invention, the light collecting apertures collect intensity time history data but do not record it until an occultation event is detected. In one or more embodiments of the invention, the light collecting apertures record the intensity time history data at programmed intervals. In an embodiment of the invention, the programmed intervals coincide with anticipated stellar occultation events.

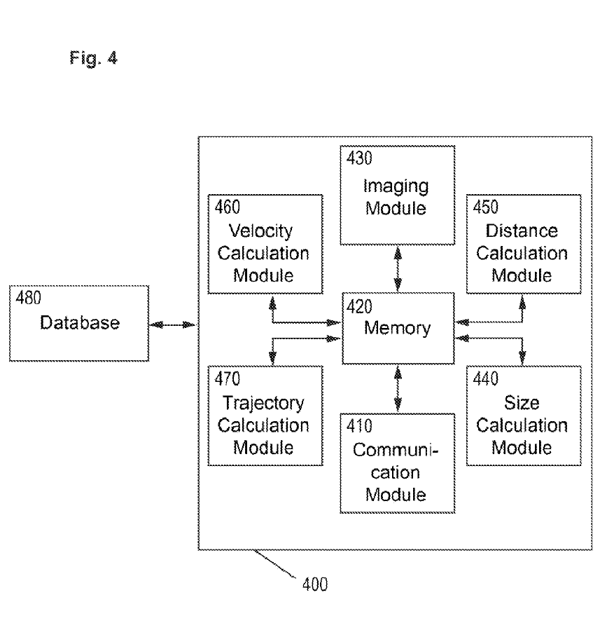

FIG. 4 shows a detailed view of the data analysis module 400 in accordance with one or more embodiments of the present invention. In this embodiment of the invention, the data analysis module 400 is a processing unit configured to collect, record, and analyze intensity time history data. In one or more embodiments of the invention, the data analysis module 400 may be a computer capable of processing the intensity time history data and having a screen for displaying the image of the occulting near-Earth object. In an alternate embodiment of the invention, the data analysis module 400 is a server or other data processing unit with a memory. In an embodiment of the invention, the data analysis module 400 is connected to a printer or other peripheral imaging device. In one or more embodiments of the invention, the data analysis module 400 is connected to a database 480 or other data repository for storage of intensity time history data, object characteristic, or imaging data for each occultation event processed by the receiving station.

The data analysis module 400 may include a communications module 410, an internal memory 420, an imaging module 430, a size calculation module 440, a distance calculation module 450, a velocity calculation module 460, and a trajectory calculation module 470.

The communications module 410 may be configured to receive intensity time history data from the light collecting apertures. In an embodiment of the invention the communications module 410 may be further configured to receive a signal from the light collecting aperture indicating that an occultation event has been detected. In one or more embodiments of the invention the communication module 410 is further configured to send intensity time history data, object characteristic, or imaging data of an occulting near-Earth object. In an embodiment of the invention, the communications module 410 may send intensity time history data, object characteristic, or imaging data of an occulting near-Earth object to a database or other data repository. In an embodiment of the invention the communications module 410 may be configured to send a signal to the light collecting apertures to begin collecting intensity time history data. In an embodiment of the invention, the communications module 410 may be configured to send a signal to the light collecting apertures to end collecting intensity time history data. In an embodiment of the invention, the communications module 410 may be configured to send an instruction to the light collecting apertures including a schedule of occultation events indicating start and end times for collecting intensity time history data.

The internal memory 420 of the data analysis module 400 may be configured to store intensity time history data of an occultation event received by the communications module. The internal memory 420 may be further configured to store processing data that may need to be accessed by the individual calculation modules including the imaging module, size calculation module 440, distance calculation module 450, velocity calculation module 460, and trajectory calculation module 470. The size of the occulting near-Earth object may be determined by the size calculation module 440. The distance of the occulting near-Earth object may be determined by the distance calculation module 450. The velocity of the occulting near-Earth object may be determined by the velocity calculation module 460. In an embodiment of the invention, the diameter of the array projected onto the direction of motion of the shadow of the occulting near-Earth object factoring in a time delay is used to calculate the velocity of the object. The trajectory of the occulting near-Earth object may be determined by the trajectory calculation module 470. In one or more embodiments of the invention, the trajectory of the occulting near-Earth object may be used to determine future occultation events.

Returning to FIG. 1, a circular array of twelve light collecting apertures 2500 m in radius, with its plane normal to the line of sight to the star are positioned on Earth's surface. The light collecting apertures are evenly spaced at 30 degrees separation on the perimeter of the circular array. In this embodiment of the invention each light collecting aperture records the intensity of light from a star, passed through a band-limited filter with center at 0.5μ wavelength. When an asteroid occults the star, its shadow passes over the plane occupied by the array. The (X,Y) axes define the local coordinate system of the array. It is assumed that the array diameter encompasses most of the cross-section of the territory swept through by the asteroid shadow

Note that for a circular array, as in FIG. 1, if the intensity time history data collected by two diametrically opposite light collecting apertures are nearly identical except for a time delay, the diameter connecting them is approximately parallel to the direction of motion of the shadow. The light collecting aperture with the temporal lead establishes the sense of direction along the diameter. The temporal cross-correlations of each of the six pairs of opposed apertures and the maximum correlation and corresponding time delay may be computed so that the diameter connecting the pair with the largest correlation maximum determines an estimate of the direction of motion. In FIG. 1, the light collecting apertures with the largest maximum cross-correlation give an initial estimate of direction to within approximately 30 degrees. To refine the estimate, Lagrange interpolation along the Y axis is used to provide a nearly continuous map of the shadow distribution as a function of time and distance i.e. distance in the (X,Y) plane normal to the preliminary estimate of the direction of motion. Then the cross-correlations of all diametrically opposed pairs of the light collecting apertures on the array periphery may be calculated as before, but using a finer increment of angular direction. Again, the diameter corresponding to the largest maximum cross-correlation indicates the direction. Performing iterations of this method calculates the direction of motion as right-to-left along the line 5° clockwise from the line connecting the center of the array and a light collecting aperture. These calculations may be used by the trajectory calculation module to determine the trajectory of the near-Earth object.

Using just this data, a number of significant parameters can be estimated. The intensity distribution is heavily diffracted, but some well known diffraction algorithms allow us to estimate the size, with may be performed by the size calculation module 440, and distance, which may be performed by the distance calculation module 450, of the near-Earth object from the extent of the relatively deep shadow and the width of the striations that immediately surround it.

In one or more embodiments of the invention the size, distance, velocity, and trajectory of the occulting near-Earth object may be analyzed to indicate whether the occulting near-Earth object poses an impact threat to Earth. In an embodiment of the invention, the size, distance, velocity, and trajectory of the occulting near-Earth object may be sent via the communications module to a central impact alert system.

The imaging module 430 may be configured to run an algorithm to create an image of the occulting near-Earth object using intensity time history data. In one or more embodiments of the invention, the imaging module 430 creates an actual silhouette of the near-Earth object in the form of a pixellated image. In an exemplary embodiment of the invention, this pixellated image has roughly 10 to 20 pixels on a side. This embodiment implies the shadow pattern needs to have a spatial resolution corresponding to 10-20 measurements across the cross-track direction and time history measurements (representing intensity variation in the along-track direction) during time intervals at most 0.1 to 0.05 of the duration of the passage of the near-Earth object across the array. In one or more embodiments of the invention, the imaging module 430 clarifies the accuracy of the image using a signal-to-noise ratio.

The imaging algorithm is detailed below. In an embodiment of the invention, the algorithm for creating the a sharp silhouette image of the occulting near-Earth object includes producing a shadow function, applying a phase retrieval algorithm to determine the complex field amplitude at position vector x=(x,y) on the plane normal to the line-of-sight at the array location, and applying an inversion technique using a silhouette function.

Shadow Function

The shadow function is the shadow pattern intensity relative to that of the unobstructed star is the square of the magnitude of the complex field amplitude, U(x), at position vector x=(x,y) on the plane normal to the line-of-sight at the array location. This may be represented as:

$$\vec{I ( x )} = {\vert \vec{U ( x )} \vert}^{2} .$$

The complex field amplitude U(x,y) at coordinates (x,y) on the plane normal to the line-of-sight at the array location is:

$$U ( x , y ) = \frac{\overline{z}}{λ} \int d {θ}_{x} \int d {θ}_{y} [ Γ ( {θ}_{x} , {θ}_{y} ) {e}^{\frac{l π \overline{z}}{λ} ( {θ}_{x}^{2} + {θ}_{y}^{2} )} ] {e}^{- 2 π i \frac{1}{λ} ( x {θ}_{x} + y {θ}_{y} )}$$

where λ is the mid-band wavelength, z̅ the distance of the observers to the occulting near-Earth object, and (θₓ, θ_{y}) are coordinates on a plane very close to the occulting near-Earth object divided by z̅.

If the star is treated as a point source, the complex field amplitude at position vector x=(x,y) is given by:

$$U ( \vec{x} ) = {U}_{p s} ( λ , \overline{z} , \vec{x} ) = \frac{\overline{z}}{λ} \int {d}^{2} θ [ Γ ( \vec{θ} ) {e}^{\frac{i x z}{λ} {\vert \vec{θ} \vert}^{2}} ] {e}^{- 2 π i \frac{Γ}{λ} x • \vec{θ}} .$$

The imaging module 430 may calculate U(x) at position vector x=(x,y) on the plane normal to the line-of-sight at the array location and use it to determine a silhouette function.

In an alternate embodiment of the invention, if the light source is treated as an extended incoherent source, then the total shadow pattern is given by the convolution integral

$${\vec{{I}_{tot} ( x )} = {\int }_{\overline{λ} - Δλ / 2}^{\overline{λ} + Δλ / 2} d λ \int {d}^{2} {θ}^{′} B ( \overline{λ , {θ}^{′}} ) \overline{\vert \vec{{U}_{ps} ( x - \overline{\overline{z}} {θ}^{′} )}} \vert}^{2}$$

where B(λ,θ′) is the normalized spectral radiance of the light from the source transmitted by a suitable gray band-limited filter with band-pass width, Δλ, and center band wavelength λ̅, at the look angle position vector θ′. Given the intensity pattern Iₜₒₜ(x), the imaging module may use Iₜₒₜ(x) and U(x) to compute the silhouette function.

The integral over the wavelength tends to smooth the fluctuations in

$${\vert \vec{{U}_{ps} ( x - \overline{\overline{z}} {θ}^{′} )} \vert}^{2} ,$$

reducing the contrast of the striations bordering the shadow interior. To maintain an acceptable level of contrast, the spectral resolution of the filter, Rⱼ=λ̅/Δλ, must be approximately 10. If the spectral radiance of the filtered source is slowly varying over the filter wave-band, then Iₜₒₜ(x) may be approximated by:

$$\vec{{I}_{tot} ( x )} ≅ Δλ \int {d}^{2} {θ}^{′} B ( \overline{λ} , {θ}^{′} ) {\vert \vec{{U}_{ps} ( \overline{λ} , x - \overline{\overline{z}} {θ}^{′} )} \vert}^{2}$$

In this form, the imaging module 430 is able to calculate the silhouette function using a phase retrieval algorithm.

Phase Retreival Algorithm

The phase retrieval problem occurs widely in astronomy, crystallography and electron microscopy. In these applications, the images (intensity distributions) being reconstructed are typically some object, say a planet or molecular structure, with a dark background, thus having finite support. The objective is to reconstruct the image, typically pixellated, when only the magnitude of its Fourier transform is known. This is possible when the dark background furnishes sufficiently many image-domain constraints, i.e. the restriction that the background pixels are black. For the most part, phase retrieval is formulated to address discretized data, and the object is to determine a pixellated image given the modulus of the (discrete) Fourier transform.

In one embodiment of the invention, the imaging module 430 calculates |U(x,y)|², while U(x,y) is the Fourier transform of a known function,

$${e}^{\frac{i π \overline{z}}{λ} ( {θ}_{x}^{2} + {θ}_{y}^{2} )}$$

multiplied by Γ(θₓ,θ_{y}), or the silhouette function. The imaging module 430 exploits some special features that differ from the typical phase retrieval situation. For example, there are more image domain constraints here than in the traditional problem: All background pixels in Γ(θₓ,θ_{y}) are uniformly unity, while pixels within the silhouette are zero. Since all pixels are constrained, this leads to faster, more reliable convergence and much greater tolerance of measurement noise in the modulus data. Once U(x,y) is determined, one can invert

$$\vec{I ( x )} = {\vert \vec{U ( x )} \vert}^{2}$$

to obtain:

$$Γ ( {θ}_{x} , {θ}_{y} ) = \frac{1}{λ \overline{z}} {e}^{- \frac{i π \overline{z}}{λ} ( {θ}_{x}^{2} + {θ}_{y}^{2} )} \int dx \int dy [ U ( \vec{x} ) ] {e}^{2 π i \frac{1}{λ} ( x {θ}_{x} + y {θ}_{y} )}$$

Borrowing the notations of Equations

$$\vec{I ( x )} = {\vert \vec{U ( x )} \vert}^{2}$$

and

$$U ( x , y ) = \frac{\overline{z}}{λ} \int d {θ}_{x} \int d {θ}_{y} [ Γ ( {θ}_{x} , {θ}_{y} ) {e}^{\frac{i π \overline{z}}{λ} ( {θ}_{x}^{2} + {θ}_{y}^{2} )} ] {e}^{- 2 π i \frac{1}{λ} ( x {θ}_{x} + y {θ}_{y} )} ,$$

we are given the data: J(x,y)=|Ũ(x,y)|² where Ũ(x,y) is the counterpart of U(x,y) in

$$\vec{I ( x )} = {\vert \vec{U ( x )} \vert}^{2} .$$

In phase retrieval applications, Ũ(x,y) is the optical coherence, not the complex field amplitude. Also far-field radiation can be assumed, in which case the exponential,

$$exp ( \frac{i π \overline{z}}{λ} ( {θ}_{x}^{2} + {θ}_{y}^{2} ) )$$

in

$$\vec{I ( x )} = {\vert \vec{U ( x )} \vert}^{2}$$

is approximately unity. Then Ũ(x,y) is given by the Fourier transform relation:

$$\tilde{U} ( x , y ) = \frac{\overline{z}}{λ} \int d {θ}_{x} \int d {θ}_{y} \tilde{Γ} ( {θ}_{x} , {θ}_{y} ) {e}^{- 2 π i \frac{1}{λ} ( x {θ}_{x} + y {θ}_{y} )}$$

where \check{Γ}(θₓ,θ_{y}), the counterpart of the term

$$\vec{I ( x )} = {\vert \vec{U ( x )} \vert}^{2} ,$$

is the image intensity distribution, not the silhouette function. In phase retrieval, \check{Γ}(θₓ,θ_{y}) is a function that may assume any real, non-negative values. With relation Ũ(x,y), the challenge is to compute \check{Γ}(θₓ,θ_{y}) given knowledge of the data, J(x,y)=|Ũ(x,y)|².

Since the phase of Ũ(x,y) is not available, a solution cannot exist unless there are additional constraints on \check{Γ}(θₓ,θ_{y}). These usually take the form of constraints on the value of \check{Γ}(θₓ,θ_{y}), (usually that it vanishes), over some region in the (θₓ,θ_{y}) plane. Many methods of phase retrieval are based on known methods that proceed by imposing a sequence of projections designed to converge to satisfaction of both the image-domain constraints (zero values of \check{Γ}(θₓ,θ_{y}) in a specified region), and the Fourier domain constraints (the specified values of J(x,y)=|Ũ(x,y)|²). This involves starting with an estimate of \check{Γ}(θₓ,θ_{y}), nulling its values in the specified region, taking its Fourier transform, correcting the modulus in conformity with J(x,y)=|Ũ(x,y)|², taking the inverse transform to obtain the next estimate of \check{Γ}(θₓ,θ_{y}) and repeating the process until (or if) acceptable convergence is attained. The algorithm, however, is very susceptible to local minima and frequently stagnates before convergence.

In another embodiment of the invention, the image domain constraint imposition is modified through known methods so that instead of rigidly setting the values of \check{Γ}(θₓ,θ_{y}) in the constraint region to zero, a step is taken towards imposing the constraint based on the previous iterate. This offers enormous improvement with very infrequent incidence of stagnation.

The two methods above assume that the image domain constraint region is known. This work suggests that a priori knowledge of the (θₓ,θ_{y}) plane region wherein \check{Γ}(θₓ,θ_{y})=0 may not be necessary. Successful phase retrieval appears possible as long as it is known a priori that the constraint region encompasses at least half the total extent of the image (half the number of pixels in the discrete case).

If the light source is treated as an extended incoherent source, then the Fourier transform pair may be defined as:

$${F}_{u} [ \vec{f ( x )} ] = \vec{{\int }_{- ∞}^{∞} {d}^{2} xf ( x ) {e }^{2 \vec{π i u} \vec{• x}}}$$

$${F}_{x}^{- 1} [ \vec{F ( u )} ] = \vec{{\int }_{- ∞}^{∞} {d}^{2} uF ( u ) {e }^{- 2 \vec{π i u} \vec{• x}}} .$$

Then, taking the Fourier transform of both sides of the above equation and employing the convolution theorem, results in:

$${F}_{u} [ {I}_{tot} ( \vec{x} ) ] = Δ λ \frac{1}{{z}^{2}} {F}_{u} [ B ( \overline{λ} , \vec{ϕ} / \overline{z} ) ] {F}_{u} [ {\vert {U}_{p s} ( \overline{λ} , \vec{x} ) \vert}^{2} ]$$

Solving for |Uₚₛ(λ̅,x̅)| in the above equation and inverting the relationship for Γ(θₓ,θ_{y}) gives:

$$\vert {U}_{p s} ( \overline{λ} , \vec{x} ) \vert = \sqrt{{F}_{x}^{- 1} [ \frac{{\overline{z}}^{2}}{Δ λ} \frac{{F}_{u} [ {I}_{tot} ( \vec{x} ) ]}{{F}_{u} [ B ( \overline{λ} , ϕ / \overline{z} ) ]} ]}$$

$$Γ ( \vec{θ} ) = \frac{1}{λ z} {e}^{- \frac{i x \overline{z}}{λ} {\vert \vec{θ} \vert}^{2}} \int {d}^{2} x [ {U}_{p s} ( \overline{λ} , \vec{x} ) ] {e}^{2 π i \frac{Γ}{λ} x • \vec{θ}}$$

where in most instances one may employ a Gaussian approximation for Fᵤ[B(λ̅,φ̅/z̅)], so that the denominator of |Uₚₛ(λ̅,x̅)| has no zeros. |Uₚₛ(λ̅,x̅)| gives the magnitude of the field amplitude in terms of the recorded intensity. When combined with image-domain constraints on the silhouette (pixels are either zero or unity), this information can yield the complete field amplitude (both magnitude and phase) via the phase retrieval algorithm. The second equation resulting from the inversion above shows that the silhouette is then determined by the inverse Fourier transform of Uₚₛ(λ̅,x)

The restriction on the spectral resolution, while preserving the contrast in the shadow pattern may sometimes unduly impair the signal-to-noise ratio. In an embodiment of the invention, a battery of narrow band filters with contiguous, non-overlapping pass bands that span a wide wavelength range is used as the light collecting apertures. Each filter band has an associated photodetector and a high spectral resolution. To be specific, suppose that there are N_{C} such wavelength channels, all of equal width, Δλ_{C}, spanning the visible band, Δλ_{V}=λ_{V2}−λ_{V1}. The mid-band wavelength of channel k is:

λ̅_{Ck}=λ_{V1}+(2k−1)Δλ_{C}

for k=1,2, . . . ,N. Then

$$\vec{{I}_{tot} ( x )} ≅ Δλ \int {d}^{2} {θ}^{′} B ( \overline{λ} , {θ}^{′} ) {\vert \vec{{U}_{ps} ( \overline{λ} , x - \overline{\overline{z}} {θ}^{′} )} \vert}^{2}$$

$${I}_{tot} ( \vec{x} ) = {\sum }_{k = 1}^{N} {I}_{k} ( {\overline{λ}}_{Ck} , \vec{x} )$$

can be written:

$${I}_{k} ( \vec{{\overline{λ}}_{Ck} , x} ) = {Δλ}_{C} \int {d}^{2} {θ}^{′} B ( \vec{{\overline{λ}}_{Ck} , {θ}^{′}} ) {\vert \overline{\vec{{U}_{ps} ( {\overline{λ}}_{Ck} , x - \overline{\overline{z}} {θ}^{′} )}} \vert}^{2} .$$

Each channel may be processed independently by the imaging module 430 in a manner analogous to

$$\vert {U}_{p s} ( \overline{λ} , \vec{x} ) \vert = \sqrt{{F}_{x}^{- 1} [ \frac{{\overline{z}}^{2}}{Δ λ} \frac{{F}_{u} [ {I}_{tot} ( \vec{x} ) ]}{{F}_{u} [ B ( \overline{λ} , \vec{ϕ} / \overline{z} ) ]} ]}$$

and then the results may be combined to

$$Γ ( \overline{θ} ) = \frac{1}{λ z} {e}^{- \frac{i x \overline{z}}{λ} {\vert \vec{θ} \vert}^{2}} \int {d}^{2} x [ {U}_{p s} ( \overline{λ} , \vec{x} ) ] {e}^{2 π i \frac{Γ}{λ} \vec{x} • \overline{θ}}$$

achieve much improved signal-to-noise ratio while preserving adequate spectral resolution and contrast.

It should be noted that even when all constraints are satisfied, there can be ambiguities in the solution. The trivial ambiguities are those transformations of the image that do not affect the Fourier transform modulus. These comprise translations of the image in the picture plane and 180° rotations. Nontrivial ambiguities arise when the image is itself the convolution of two or more other images. This relatively rare phenomenon gives rise to multiple possible solutions.

Silhouette Function

Generally, the imaging module 430 scans the pixels in the silhouette plane using a simple raster scan or some other scanning algorithm and for each pixel, changes the value (from unity to zero or vice versa), computes the modified shadow pattern, and then determines the cross correlation with the shadow pattern data to generate an image of the near-Earth object.

Silhouette function calculation can be seen to be very similar to phase retrieval: data on the modulus of a quantity, U(x,y), is known, which is related via Fourier transformation to a known function

$$exp ( \frac{i π \overline{z}}{λ} ( {θ}_{x}^{2} + {θ}_{y}^{2} ) )$$

multiplied by the function of interest, Γ(θₓ,θ_{y}). Provided that the detection array is appropriately sized, a region of sufficient extent wherein Γ(θₓ,θ_{y}) vanishes is known. Additionally the silhouette function only assumes the values zero or unity. The silhouette function may be defined by:

$$Γ ( {θ}_{x} , {θ}_{y} ) = \{ \begin{matrix}0 , if θ is inside the asteroid profile \\ 1 , otherwise\end{matrix} .$$

In one or more embodiments, the silhouette function is represented as a pixellated image in the (xₐ,yₐ) plane, where each matrix element is either zero or unity. In principle, the search space is finite, and there is a finite-step algorithm that may converge to a solution for which all constraints are satisfied. With respect to ambiguities, note that by the conditions of the problem, the silhouette is known to be surrounded by uniform intensity, so translations may be eliminated by shifting the silhouette pattern in the picture frame. There is also a one-to-one relation between the orientation of the shadow pattern and the silhouette so that rotational ambiguity is not possible. Further, nontrivial ambiguities are unlikely because the convolution of silhouette functions with other silhouette functions must have values greater than unity.

Let \check{Γ}ε [symbol] ^{M×M} and Jε [symbol] ^{M×M} and be the matrices of the trial values of the image and of the specified Fourier transform modulus, and denote the discrete Fourier transform by F( . . . ). The error metric is defined by:

$$ɛ = \frac{1}{2} {\sum }_{m = 1}^{M} {\sum }_{n = 1}^{M} {( {J}_{mn} - \vert {F}_{mn} ( \tilde{F} ) \vert )}^{2} .$$

The silhouette function conducts a raster scan of the M×M image plane. At each pixel, the color (0 or 1) is changed and the error metric is computed. If the error is reduced from the previous step, the new color is retained; otherwise the color change is rescinded. The raster scan is performed iteratively until the actual image is sharp enough to meet a threshold or perfectly reproduced, except for a translation in the image plane.

From

$$U ( x , y ) = \frac{\overline{z}}{λ} \int d {θ}_{x} \int d {θ}_{y} [ Γ ( {θ}_{x} , {θ}_{y} ) {e}^{\frac{i π \overline{z}}{λ} ( {θ}_{x}^{2} + {θ}_{y}^{2} )} ] {e}^{- 2 π i \frac{1}{λ} ( x {θ}_{x} + y {θ}_{y} )} ,$$

the shadow intensity distribution is:

$$Ψ ( x , y ) = {\vert \frac{1}{λ \overline{z}} \int {dx}_{a} \int {dy}_{a} [ ( 1 - \overline{Γ} ( {x}_{a} , {y}_{a} ) ) {e}^{\frac{i π}{λ \overline{z}} ( {x}_{a}^{2} + {y}_{a}^{2} )} ] {e}^{- 2 π i \frac{1}{λ \overline{z}} ( {xx}_{a} + {yy}_{a} )} \vert}^{2}$$

where Γ̅(xₐ,yₐ) is a complementary silhouette function:

$$\overline{Γ} ( {x}_{a} , {y}_{a} ) = \{ \begin{matrix}1 , if {x}_{a} is inside the asteriod profile \\ 0 , otherwise\end{matrix} .$$

In other words, this is the reverse color version of the sharp shadow. The introduction of Γ̅(xₐ,yₐ) is convenient because the integration over the unity integrand in

$$Ψ ( x , y ) = {\vert \frac{1}{λ \overline{z}} \int {dx}_{a} \int {dy}_{a} [ ( 1 - \overline{Γ} ( {x}_{a} , {y}_{a} ) ) {e}^{\frac{i π}{λ \overline{z}} ( {x}_{a}^{2} + {y}_{a}^{2} )} ] {e}^{- 2 π i \frac{1}{λ \overline{z}} ( {xx}_{a} + {yy}_{a} )} \vert}^{2}$$

can be carried out at once to yield:

Ψ(x,y)=|U|²

U=i−F∫_{-∞}^{∞}dφₓ∫_{-∞}^{∞}dφ_{y}Γ̅(φₓ,φ_{y})e^{iπF[(φ}^{ₓ}^{-w}^{ₓ}⁾^{²}^{+(φ}^{_{y}}^{-w}^{_{y}}⁾^{²}^{]}

where the previous estimate of the near-Earth object radius, a, is used to define non-dimensional variables:

$${ϕ}_{x} = {x}_{a} / a , {ϕ}_{y} = {y}_{a} / a$$

$${w}_{x} = x / a , {w}_{y} = y / a$$

and where F is the corresponding Fresnel number.

With the above expressions, relating Γ̅(φₓ,φ_{y}) to Ψ(x,y) may be performed using a data processing device such as a computer or server. In an embodiment of the invention, these quantities are represented by matrices having numbers of rows and columns as (294×294). This gives us a digital framework for fine resolution rendering of the shadow pattern and complementary silhouette function. For approximating the silhouette, we define a pixellated image where the pixels are squares that are multiple fine-resolution pixels on a side. In this specific case there are 21 by 21 low resolution pixels that are used to define the complementary silhouette. The shadow function is the square of the magnitude of a field amplitude that is built up from a combination of the field amplitudes of individual 14 by 14 pixel squares. These amplitude distributions are computed using the analytical formula for the integral in U of

Ψ(x,y)=|U|²

U=i−F∫_{-∞}^{∞}dφₓ∫_{-∞}^{∞}dφ_{y}Γ̅(φₓ,φ_{y})e^{iπF[(φ}^{ₓ}^{-w}^{ₓ}⁾^{²}^{+(φ}^{_{y}}^{-w}^{_{y}}⁾^{²}^{]}

assuming Γ̅(φₓ,φ_{y}) is unity only over the single coarse resolution pixel. For example, the amplitude of a single coarse resolution pixel that is β fine resolution pixels wide, and is centered at the origin is:

$$U ( {w}_{x} , {w}_{y} ) = i - \frac{1}{2} [ E ( \sqrt{2 {F}^{′}} ( β - {w}_{x} ) ) + E ( \sqrt{2 {F}^{′}} ( β + {w}_{x} ) ) ] [ E ( \sqrt{2 {F}^{′}} ( β - {w}_{y} ) ) + E ( \sqrt{2 {F}^{′}} ( β + {w}_{y} ) ) ]$$

where: E(ξ)=C(ξ)+iS(ξ) and F′ is the corresponding Fresnel number. This calculation is not repeated for every coarse resolution pixel for which Γ̅(φₓ,φ_{y}) is unity; rather, the imaging module 430 computes U(wₓ, w_{y}) for a double sized domain to obtain a 588×588 matrix, and then uses appropriately shifted versions of this matrix to accumulate the total field amplitude for all coarse resolution pixels having Γ̅(φₓ,φ_{y})=1. Taking the square of the magnitude of the total field amplitude, we get the matrix of values of Ψ(x,y) at all the fine-resolution pixel locations.

In an embodiment of the invention, the imaging module 430 may use this method of mapping Γ̅(φₓ,φ_{y}) into Ψ(x,y) to implement the simple algorithm described above for phase retrieval: scan the coarse resolution pixels, at each pixel, change the value of Γ̅(φₓ, φ_{y}), evaluate a mean square error between the estimated shadow pattern and the data analogous to criterion

$$ɛ = \frac{1}{2} {\sum }_{m = 1}^{M} {\sum }_{n = 1}^{M} {( {J}_{mn} - \vert {F}_{mn} ( \tilde{Γ} ) \vert )}^{2} ,$$

and retain the value change if there is improvement, or rescind the change if not.

However, in another embodiment of the invention, the imaging module uses a procedure that avoids any errors in the construction of the shadow pattern by directly comparing results with the raw data. To do this we take one further processing step: For given estimate of Γ̅(φₓ,φ_{y}), use the shadow pattern computed as above to synthesize the intensity time histories of the various apertures that would be observed if Ψ(x,y) were the true shadow pattern. This is described further below under The Alignment Method.

Alignment Method

In another embodiment of the invention, the time history data may be aligned by using the travel velocity to transform times to distances normal to the direction of travel so that the phase retrieval may be applied directly without a complete reconstruction of the shadow function. This is the shadow pattern, i.e. the normalized intensity distribution over the plane parallel to the plane of the array that moves with the shadow. Using just this data, a number of significant parameters may be estimated. The intensity distribution is heavily diffracted, but the relations and some well known diffraction results allow the data analysis module to estimate the size and distance of the near-Earth Object from the extent of a relatively deep shadow and the width of the striations that immediately surround it.

First, let us consider the information on the near-Earth object distance implied by the shadow function. Referring to

$$U ( x , y ) = \frac{\overline{z}}{λ} \int d {θ}_{x} \int d {θ}_{y} [ Γ ( {θ}_{x} , {θ}_{y} ) {e}^{\frac{i π \overline{z}}{λ} ( {θ}_{x}^{2} + {θ}_{y}^{2} )} ] {e}^{- 2 π i \frac{1}{λ} ( x {θ}_{x} + y {θ}_{y} )} ,$$

recall that (φₓ,φ_{y}) are coordinates on a plane very close to the occulting object divided by z̅. Suppose that (xₐ,yₐ) are the corresponding Cartesian coordinates on this plane, so that:

θₓ=xₐ/z̅,θ_{y}=yₐ/z̅

In terms of

$$( {x}_{a} , {y}_{a} ) , \\ U ( x , y ) = \frac{\overline{z}}{λ} \int d {θ}_{x} \int d {θ}_{y} [ Γ ( {θ}_{x} , {θ}_{y} ) {e}^{\frac{i π \overline{z}}{λ} ( {θ}_{x}^{2} + {θ}_{y}^{2} )} ] {e}^{- 2 π i \frac{1}{λ} ( x {θ}_{x} + y {θ}_{y} )}$$

may be written:

$$U ( x , y ) = \frac{1}{λ \overline{z}} \int d {x}_{a} \int {dy}_{a} [ Γ ( {x}_{a} , {y}_{a} ) {e}^{\frac{i π}{λ \overline{z}} ( {x}_{a}^{2} + {y}_{a}^{2} )} ] {e}^{- 2 π i \frac{1}{λ \overline{z}} ( {xx}_{a} + {yy}_{a} )} .$$

While the field amplitude depends on the geometry of the silhouette function, the only other parameter is λz̅. Furthermore the edges of the silhouette are adjoined by linear bands of intensity maxima. When the width of the silhouette is somewhat larger than the width of these striations, the intensity pattern in the vicinity of an edge asymptotically approaches that of an infinite straight edge shadow, where light is blocked by an opaque half-plane, y<0. This intensity distribution takes the form:

$$Ψ ( y ) = \frac{1}{2} {\vert C ( \sqrt{\frac{2}{λ \overline{z}}} y ) + iS ( \sqrt{\frac{2}{λ \overline{z}}} y ) + \frac{1}{2} ( 1 + i ) \vert}^{2}$$

where C( . . . ) and S( . . . ) are the Fresnel integrals. Equations

$$U ( x , y ) = \frac{1}{λ \overline{z}} \int d {x}_{a} \int {dy}_{a} [ Γ ( {x}_{a} , {y}_{a} ) {e}^{\frac{i π}{λ \overline{z}} ( {x}_{a}^{2} + {y}_{a}^{2} )} ] {e}^{- 2 π i \frac{1}{λ \overline{z}} ( {xx}_{a} + {yy}_{a} )}$$

and

$$Ψ ( y ) = \frac{1}{2} {\vert C ( \sqrt{\frac{2}{λ \overline{z}}} y ) + iS ( \sqrt{\frac{2}{λ \overline{z}}} y ) + \frac{1}{2} ( 1 + i ) \vert}^{2}$$

make it clear that the distance to the near-Earth object can be estimated from the width of the striations.

In an exemplary embodiment of the invention, the width of the first lobe in

$$Ψ ( y ) = \frac{1}{2} {\vert C ( \sqrt{\frac{2}{λ \overline{z}}} y ) + iS ( \sqrt{\frac{2}{λ \overline{z}}} y ) + \frac{1}{2} ( 1 + i ) \vert}^{2}$$

that is above unit intensity is, in terms of the non-dimensional argument, 1.275. The width of the portion of the striations in an exemplary embodiment of the invention is approximately 130 m. Setting

$$\sqrt{\frac{2}{λ \overline{z}}} Δ y \sim 1.275 ; Δ y = 130 m$$

gives: z̅=4.19×10¹⁰ m=0.280 AU

In an embodiment of the invention, the image may show an intensity hole. In an exemplary embodiment of the invention, the diameter roughly 106 pixels, or approximately 2120 m on the average. The imaging module 430 then applies:

$$W = Width of deep shadow = 2 ( a + \frac{λ \overline{z}}{a} )$$

where a denotes the average radius of the near-Earth object. Setting W=2120 m and solving for a yields a=20.1 m. Using these values and z̅=4.19×10¹⁰ m=0.280 AU, the Fresnel number is:

$$F = \frac{{a}^{2}}{λ \overline{z}} = 0.0193 .$$

In an embodiment of the invention, the imaging module 430 uses a procedure in the construction of the shadow pattern by directly comparing results with the raw data. To do this the imaging module takes one further processing step: Given estimate of Γ̅(φₓ,φ_{y}), the imaging module 430 uses the shadow pattern computed as above to synthesize the intensity time histories of the various light collecting apertures that would be observed if Ψ(x,y) were the true shadow pattern. To compare the computed time histories with the basic data, the imaging module 430 may use a mean-square criterion or a correlation coefficient between the computed histories and the time history data. In an exemplary embodiment of the invention, M (Γ̅)ε [symbol] ^{N}^{ₐ}^{×M}^{_{S}} denotes the matrix of computed time histories corresponding to an estimate, Γ̅ε [symbol] ^{21×21} of the complementary silhouette. Each of the Nₐ rows contains the computed time history of a light collecting aperture, and each time history is a sampled data string M_{S} elements long. Let Mₜᵣᵤₑ be the corresponding data matrix. A correlation coefficient, between the true and the estimated time history data may be defined as:

$$Cor ( \overline{Γ} ) = \frac{{\sum }_{m = 1}^{{N}_{a}} {\sum }_{n = 1}^{{M}_{S}} {( M ( \overline{Γ} ) ⊙ {M}_{true} )}_{m , n}}{\sqrt{[ {\sum }_{p = 1}^{{N}_{a}} {\sum }_{q = 1}^{{M}_{S}} {( M ( \overline{Γ} ) ⊙ M ( \overline{Γ} ) )}_{p - q} ] [ {\sum }_{r = 1}^{{N}_{a}} {\sum }_{s = 1}^{{M}_{S}} {( {M}_{true} ⊙ {M}_{true} )}_{r , s} ]}}$$

where ⊙ denotes the Hadamard product. The summations are the squares of vector 2-norms induced in the space of Nₐ×M_{S} matrices. Given the above equations, Cor(Γ̅)ε[0,1] and Cor(Γ̅)=1 if and only if M(Γ̅)=Mₜᵣᵤₑ. The imaging module 430 raster scans the elements of Γ̅ε [symbol] ^{21×21}; for each element, the imaging module 430 changes the value, and computes M(Γ̅) and Cor(Γ̅)ε[0,1]. If Cor(Γ̅) is larger than its previous value, the imaging module 430 retains the new value (0 or 1). Otherwise, it restores the old value. In an embodiment of the invention, the imaging module 430 assigns unity value to the coarse resolution pixel that is at the center of the image in order to help center the image.

In summary, using the Alignment Method, data analysis module may use the aligned data and the shadow function alone to provide estimates of the apparent velocity of the near-Earth object, its approximate size and distance and Fresnel number of the shadow.

Photon Arrival Rates

In an exemplary embodiment of the invention each light collecting aperture will measure intensity in the visible to near infrared range. Even with very narrow band filtering of collected light, the response time of even fast Avalanche Photodiode detectors is much larger than the correlation time of the light. With this “slow detector” condition, the arrival time statistics of photon detections is fully characterized by the average number of photon arrivals per unit time. Further, the standard deviation of the number of photons entering a detector over a given time period is equal to the square root of the average multiplied by the time interval. The average number of photon detections divided by the standard deviation is the signal-to-noise of the measured average intensity over the measurement interval.

As the basis for our estimate of average photon detection rate, the Planck radiation law for the spectral radiance per unit wavelength is used:

$${B}_{λ} ( {T}_{*} ) = \frac{2 {hc}^{2}}{{λ}^{5}} \frac{1}{{e}^{hc / λ {kT}_{*}} - 1} ( W - {sr}^{- 1} - {m}^{- 3} )$$

$$h = 6.626 \times {10}^{- 34} J - s$$

$$k = 1.38 \times {10}^{- 23} J - {K}^{- 1}$$

$$c = 2.998 \times {10}^{8} m - {s}^{- 1}$$

where λ is the wavelength, and T_{*} is the photospheric temperature of the occulted star. Integrating over the appropriate solid angle, the radiance from a unit area of surface is πrB_{λ}(T_{*}) (W−m⁻³) Then, dividing by hν, where ν=c/λ, the number of photons emitted per unit surface, per unit wavelength, per second is:

$${N}_{λ} ( {T}_{*} ) = 2 π \frac{c}{{λ}^{4}} \frac{1}{{e}^{hc / λ {kT}_{*}} - 1} .$$

If n_{λ}(T_{*}) denotes the number of photons received per second, per square meter per unit wavelength then, from

$${N}_{λ} ( {T}_{*} ) = 2 π \frac{c}{{λ}^{4}} \frac{1}{{e}^{hc / λ {kT}_{*}} - 1} ,$$

we have:

$${N}_{λ} ( {T}_{*} ) = 2 π ( \frac{{R}_{*}}{{d}_{*}} ) \frac{c}{{λ}^{4}} \frac{1}{{e}^{hc / λ {kT}_{*}} - 1} ( {s}^{- 1} - {m}^{- 3} )$$

where R_{*} and d_{*} are the stellar radius and distance, respectively.

In one or more embodiments of the invention, the light is passed through the j^{th} grey band-limited filter discussed above, that admits light in the wavelength range λε[λ_{Ck-1},λ_{Ck}]. Then, n_{Δλ}_{_{C}}(T_{*}, j), the average number of photons received per second, per square meter in λε[λ_{Cj-1},λ_{Cj}] is:

$${n}_{{Δλ}_{C}} ( {T}_{*} , j ) = 2 π {c ( \frac{{R}_{*}}{{d}_{*}} )}^{2} {\int }_{{\overline{λ}}_{Cj - 1}}^{{\overline{λ}}_{Cj - 1} + {Δλ}_{C}} d λ \frac{1}{{λ}^{4}} \frac{1}{{e}^{hc / λ {kT}_{*}} - 1}$$

where j=1, . . . , N_{C}.

It is convenient to express this in terms of the stellar apparent magnitude, m_{*}. In terms of solar parameters, this is given by:

$${m}_{*} = {m}_{⊙} - 2.5 {log}_{10} ( \frac{{L}_{*}}{{L}_{⊙}} {( \frac{{d}_{⊙}}{{d}_{*}} )}^{2} )$$

m_{⊙}=Solar magnitude=−26.73
d_{⊙}=Solar distance=1.58×10⁻⁵ lyr
L_{⊙}=Solar luminosity=3.846×10²⁶ W
where, using B_{λ}T_{*} the stellar luminosity is:

$$\begin{matrix}{L}_{*} = 4 π {R}_{*}^{2} \times 2 π {B}_{λ} \\ = 8 {π}^{2} {R}_{*}^{2} {hc}^{2} {\int }_{0}^{∞} d λ \frac{1}{{λ}^{5}} \frac{1}{{e}^{hc / λ {kT}_{*}} - 1} \end{matrix}$$

Applying

$${n}_{{Δλ}_{C}} ( {T}_{*} , j ) = 2 π {c ( \frac{{R}_{*}}{{d}_{*}} )}^{2} {\int }_{{\overline{λ}}_{{C}_{j - 1}}}^{{\overline{λ}}_{{C}_{j - 1} + {Δλ}_{C}}} d λ \frac{1}{{λ}^{4}} \frac{1}{{e}^{hc / λ {kT}_{*}} - 1} , \\ \begin{matrix}{L}_{*} = 4 π {R}_{*}^{2} \times 2 π {B}_{λ} \\ = 8 {π}^{2} {R}_{*}^{2} {hc}^{2} {\int }_{0}^{∞} d λ \frac{1}{{λ}^{5}} \frac{1}{{e}^{hc / λ {kT}_{*}} - 1}\end{matrix}$$

may be put in the form:

$$\frac{{L}_{*}}{{d}_{*}^{2}} = 4 π hc ( \frac{{\int }_{0}^{∞} d λ \frac{1}{{λ}^{5}} \frac{1}{{e}^{hc / λ {kT}_{*}} - 1} }{{\int }_{{\overline{λ}}_{{C}_{j - 1}}}^{{\overline{λ}}_{{C}_{j - 1} + {Δλ}_{C}}} d λ \frac{1}{{λ}^{4}} \frac{1}{{e}^{hc / λ {kT}_{*}} - 1} } ) {n}_{{Δλ}_{C}}$$

Substituting this into m_{*} and solving for n_{Δλ}_{_{C}}, we get

$${n}_{{Δλ}_{C}} ( {T}_{*} , j ) = \frac{1}{4 π hc} \frac{{L}_{⊙}}{{d}_{⊙}^{2}} {Ψ}_{j} ( {\overline{λ}}_{Cj} , {T}_{*} ) {10}^{0.4 ( {m}_{⊙} - {m}_{*} )}$$

where:

$${Ψ}_{j} ( {λ}_{Cj} , {T}_{*} ) = \frac{{\int }_{{{\overline{λ}}_{C}}_{j - 1}}^{{{\overline{λ}}_{C}}_{j - 1} + {Δλ}_{C}} d λ \frac{1}{{λ}^{4}} \frac{1}{{e}^{hc / λ {kT}_{*}} - 1}}{{\int }_{0}^{∞} d λ \frac{1}{{λ}^{5}} \frac{1}{{e}^{hc / λ {kT}_{*}} - 1} }$$

and where L_{⊙}, d_{⊙}, and m_{⊙} are the solar luminosity, distance and apparent magnitude, respectively.

In one or more embodiments of the invention, the photon arrival processes within the various non-overlapping wavelength channels are mutually statistically independent Poisson processes. Thus the average number of photons, denoted by n_{Δλ} received per second, per square meter in the entire wavelength band, λε[λ_{V1}, λ_{V2}], spanned by the N_{C} channels is, by virtue of

$${n}_{{Δλ}_{C}} ( {T}_{*} , j ) = \frac{1}{4 π hc} \frac{L}{{d}^{2}} {Ψ}_{j} ( {\overline{λ}}_{Cj} , {T}_{*} ) {10}^{0.4 ( m - {m}_{*} ) } and$$

$${Ψ}_{j} ( {λ}_{Cj} , {T}_{*} ) = \frac{{\int }_{{\overline{λ}}_{{C}_{j - 1}}}^{{\overline{λ}}_{{C}_{j - 1} + {Δλ}_{C}}} d λ \frac{1}{{λ}^{4}} \frac{1}{{e}^{hc / λ {kT}_{*}} - 1} }{{\int }_{0}^{∞} d λ \frac{1}{{λ}^{5}} \frac{1}{{e}^{hc / λ {kT}_{*}} - 1}} \text{:}$$

$${n}_{Δλ} = {\sum }_{j = 1}^{{N}_{C}} {n}_{Δλ} ( {T}_{*} , j ) = \frac{1}{4 π hc} \frac{{L}_{⊙}}{{d}_{⊙}^{2}} Ψ ( \overline{λ} , {T}_{*} ) {10}^{0.4 ( {m}_{⊙} - {m}_{*} )}$$

where:

$$Ψ ( \overline{λ} , {T}_{*} ) = \frac{{\int }_{\overline{λ} - Δλ / 2}^{\overline{λ} + Δλ / 2} d λ \frac{1}{{λ}^{4}} \frac{1}{{e}^{hc / {λ kT}_{*}} - 1} }{{\int }_{0}^{∞} d λ \frac{1}{{λ}^{5}} \frac{1}{{e}^{hc / {λ kT}_{*}} - 1}}$$

and where: λ̅=½(λ_{V1}+λ_{V2}), Δλ=λ_{V2}−λ_{V1}

Note that intensity measurements determine only the magnitude, not the phase of U (x,y) However, given that U(x,y) is essentially the Fourier transform of Γ(θₓ,θ_{y}), and given the constraints on the form of Γ(θₓ,θ_{y}) the phase can be determined by phase retrieval algorithms.

Moreover, the second central moment of the number of photon arrivals, denoted received per second, per square meter in the entire wavelength band is simply n_{Δλ}. In an exemplary embodiment of the invention, the average arrival rate is a weak function of the temperature. In an embodiment of the invention, n_{Δλ} increases slightly for the cooler stars, reflecting the fact that for a given radiance, the number of photons increases with wavelength. Hotter stars are relatively rare, while nearly 90%/o of stars are M-class. In an exemplary embodiment of the invention, when these results are averaged over the numerical distribution of spectral classes, the close the case T_{*}=3000K which is near the high end of temperatures for M stars. Thus, in this exemplary embodiment, it is reasonable to approximate all stars with the result for T_{*}=3000K and

$${n}_{Δλ} ≅ {N}_{0} \times {10}^{- 0.4 {m}_{*}}$$

$${N}_{0} ≅ 1.46 \times {10}^{10} .$$

Signal-to-Noise Ratio

To characterize the accuracy with which the silhouette may be determined the imaging module 430, in one or more embodiments of the invention, determines a signal-to-noise ratio that is reasonably convenient to calculate, yet is consistent with the phase retrieval algorithm, and relates to those critical factors in determining the accuracy of the silhouette function. In an embodiment of the invention, the imaging module 430 characterizes the error in the image of the near-Earth object as a function of the levels of noise in the intensity measurements.

In an alternate embodiment of the invention, the imaging module 430 uses intensity measurement statistics as a measure of silhouette estimation accuracy. As described above, the silhouette reconstruction method scans the pixels in the silhouette plane by some algorithm and for each pixel, changes the value (from unity to zero or vice versa), computes the modified shadow pattern from, and then determines the cross correlation with the shadow pattern data. If the cross-correlation increases, the value change is accepted; otherwise it is rescinded. This is a convex optimization problem, and as the measurement noise approaches zero, the silhouette errors also vanish. Therefore, the imaging module 430 may, in an embodiment of the invention, use the measurement noise statistics to define an signal-to-noise ratio, taking care that the “signal” part of the signal-to-noise ratio encompasses only that fraction of the intensity measurements that convey the most pertinent information on the silhouette function.

In this embodiment of the invention, the imaging module 430 characterizes the silhouette accuracy via the accuracy of the shadow pattern measurements relevant to silhouette information. In an exemplary embodiment of the invention, the imaging module 430 determines that there will be 20 pixels on a side, Nₚᵢₓ of the final pixellated image of the asteroid. In this embodiment of the invention the number of apertures distributed across the cross-track direction must be approximately Nₚᵢₓ. The end-to-end extent of the array may be at least as big as the width of the shadow region, W pertaining to the mid-band wavelength, λ̅, given by:

$$W = 2 ( a + \frac{\overline{λ} \overline{z}}{a} )$$

a=asteroid radius
λ̅=mid-band wavelength
z̅=distance of asteroid from the array
The array need not be much larger than this because the Fresnel integral fluctuations far from this shadow region contain little information about the silhouette.

In an exemplary embodiment of the invention, at 0.28 AU a 40 m diameter asteroid has a shadow width of over 2 km. A typical value for the duration of the asteroid velocity perpendicular to the line of sight, V, is approximately 10 km/s, so the entire duration of the shadow passage is roughly W/V≈0.2 s. Further, for each pixel, the intensity measurement is the total number of photodetection events recorded by the photodetector in time period Δy/V where →y=W/Nₚᵢₓ, the extent of a pixel in the observation plane.

In this embodiment of the invention, each aperture is equipped with a bank of N_{C} non-overlapping narrow band filters with associated photodetectors. Therefore,

$${U}_{ps} ( {\overline{λ}}_{Ck} , \vec{\overline{z} , x} ) = {U}_{px} ( \overline{λ} , \frac{{\overline{λ}}_{Ck}}{\overline{λ}} \overline{z} , \frac{{\overline{λ}}^{⇀}}{{\overline{λ}}_{Ck}} x ) .$$

This relation states that the shadow pattern produced by light centered at wavelength λ̅_{Ck} (over a wavelength band Δλ_{C}) is the same as that produced by light centered at λ̅ (with the same bandwidth), but with a distance to the source altered by λ̅_{Ck}/λ̅, and with a size that is dilated or contracted by factor λ̅_{Ck}/λ̅. Both sides of the equation pertain to the same silhouette at distance z̅. Since, physically, z̅ is fixed in this embodiment, the individual filters associated with each light collecting aperture sample a fan of locations on the shadow pattern observation plane. Thus, if a light collecting aperture moves along the along-track axis, the x-axis in this embodiment of the invention, such that the cross-track coordinate is a constant y=ξ, then the N_{C} filters actually sample the sample pattern at the y-coordinates:

$${y}_{k} = ζ ( 1 + \frac{k}{{N}_{C}} \frac{Δλ}{\overline{λ}} ) , k = - \frac{1}{2} {N}_{C} , … , - 1 , 0 , 1 , … , \frac{1}{2} {N}_{C} .$$

In one or more embodiments of the invention, for each pixel, the data alignment process merely adds up all the photodetector measurements that contribute to the estimated intensity associated with that pixel. The pixel measurement is a sum of independent Poisson processes corresponding to all the light collecting apertures and all the narrow band filter channels in each light collecting aperture whose along-axis tracks pass through the pixel during occultation. The main factor contributing to both the signal and the noise in the signal-to-noise ratio is the average of this quantity, evaluated for the un-occulted star. This is a function of the cross-track coordinate only. Using the equations

$${n}_{{Δλ}_{C}} ( {T}_{*} , j ) = \frac{1}{4 π hc} \frac{L}{{d}^{2}} {Ψ}_{j} ( {\overline{λ}}_{Cj} , {T}_{*} ) {10}^{0.4 ( m - {m}_{*} )} and$$

$${n}_{Δλ} = {\sum }_{j = 1}^{{N}_{C}} {n}_{Δλ} ( {T}_{*} , j ) = \frac{1}{4 π hc} \frac{L}{{d}^{2}} Ψ ( \overline{λ} , {T}_{*} ) {10}^{0.4 ( m - {m}_{*} )} ,$$

we have:

$$( \begin{matrix} Average no . of ( un \text{-} occulted ) photo \\ detections for a pixel centered at {y}_{pix}\end{matrix} ) \text{∼} η {A}_{T} {n}_{Δλ} ρ ( {y}_{pix} ) Δ y / V$$

η=Quantum efficiency of detector (=0.1-0.5)
A_{T}=Telescope aperture area
ρ(yₚᵢₓ)=Number of tracks passing through [yₚᵢₓ−½Δy, yₚᵢₓ+½Δy) divided by N_{C}
   where:

$$ρ ( {y}_{pix} ) = \frac{1}{{N}_{C}} {\sum }_{m = - \frac{1}{2} {N}_{pix}}^{\frac{1}{2} {N}_{pix}} {\sum }_{k = - \frac{1}{2} {N}_{C}}^{\frac{1}{2} {N}_{C}} \{ \begin{matrix}1 , m Δ y ( 1 + \frac{k}{{N}_{C}} \frac{Δλ}{\overline{λ}} ) ∈ [ \begin{matrix}{y}_{pix} - \frac{1}{2} Δ y , \\ {y}_{pix} + \frac{1}{2} Δ y\end{matrix} ) \\ 0 , otherwise\end{matrix} \} .$$

This function has a continuous limit as N_{C}→□, and Δy→0, and is well approximated by the limit. In an embodiment of the invention ρ(yₚᵢₓ) is a function of yₚᵢₓ divided by the aperture array width for N_{C}=Nₚᵢₓ=200, and for various values of the reciprocal of the spectral resolution,

$$\frac{1}{R} = Δλ / \overline{λ} .$$

In this embodiment of the invention, ρ(yₚᵢₓ) is somewhat above unity for a region within the aperture array, but then decreases abruptly. Thus it is desirable to make the cross-track extent of the aperture array somewhat larger than W by the factor

$$2 / ( 1 - \frac{Δλ}{2 \overline{λ}} ) .$$

Under this condition, a conservative estimate of ρ(yₚᵢₓ) is unity.
The true “signal” is not the quantity in

$$( \begin{matrix}Average no . of ( un \text{-} occulted ) photo \\ detections for a pixel centered at {y}_{pix}\end{matrix} ) \text{∼} η {A}_{T} {n}_{Δλ} ρ ( {y}_{pix} ) Δ y / V$$

η=Quantum efficiency of detector (=0.1-0.5)
A_{T}=Telescope aperture area but rather the contrast in the
ρ(yₚᵢₓ)=Number of tracks passing through [yₚᵢₓ−½Δy, yₚᵢₓ+½Δy) divided by N_{C}
   shadow intensity distribution.

In this embodiment of the invention, the contrast arising from the fluctuations in the intensity is what contributes information about the silhouette. The estimated level of contrast may be expressed as a fraction, κ, of the un-occulted average photodetections given by the above equation. To estimate κ, the imaging module 430 considers that for the range of Fresnel numbers above ˜0.1, the principal fluctuations take the form of nested striations enclosing the deep shadow region of the diffracted silhouette. The extent of the dark spot enclosed by the striations indicates the overall size of the silhouette. The fluctuation of the striations themselves combined with the estimated size indicates the distance and Fresnel number. Generally, if the system has sufficient signal-to-noise ratio to accurately model the striations, it will suffice to determine the silhouette accurately. These striations approximate the knife edge shadow pattern for a point source given by:

$${\vert U ( ξ ) \vert}^{2} = \frac{1}{2} {\vert C ( \sqrt{\frac{2}{\overline{z} \overline{λ}} ξ} ) + iS ( \sqrt{\frac{2}{\overline{z} \overline{λ}} ξ} ) + \frac{1}{2} ( 1 + i ) \vert}^{2}$$

where ξ is distance along the axis perpendicular to the striation, and C( . . . ) and S( . . . ) are the Fresnel integrals.

In summary, using the above estimate of n_{Δλ}, and the above estimates of ρ and κ, the imaging module 430 may calculate:

Average contrast measurement=ηκA_{T}N₀(Δy/V)□0^{-0.4 m,}

N₀=1.46×10¹⁰

In an embodiment of the invention, the imaging module 430 considers the noise statistics. The variance of the noise due to photon arrival statistics is ηA_{T}n_{Δλ}ρ(yₚᵢₓ)Δy/V. To this the photodectector dark count must be added, which is denoted by, n_{DC} measured in average number of photons per second. The noise variance due to dark count for each pixel measurement and all wavelength channels is n_{DC}N_{C}(Δy/V)ρ(yₚᵢₓ). Noise due to the star and the dark count are independent, so:

$$( \begin{matrix}Variance of noise in \\ one pixel measurement\end{matrix} ) = ( η {A}_{T} {n}_{Δλ} + {N}_{C} {n}_{D C} ) ρ ( {y}_{pix} ) ( Δ y / V ) .$$

The signal-to-noise ratio (SNR) of each pixel measurement of the shadow pattern is κ times expression for the average number of un-occulted photo detections for a pixel centered at yₚᵢₓ divided by the square root of expression in

$$( \begin{matrix}Variance of noise in \\ one pixel measurement\end{matrix} ) = ( η {A}_{T} {n}_{Δλ} + {N}_{C} {n}_{D C} ) ρ ( {y}_{pix} ) ( Δ y / V ) .$$

Therefore the signal-to-noise ratio of each pixel calculated by the imaging module 430 is:

$$SNR = ηκ {A}_{T} {n}_{Δλ} \sqrt{\frac{ρ ( {y}_{pix} ) Δ y / V}{( η {A}_{T} {n}_{Δλ} + {N}_{C} {n}_{D C} )}}$$

$${n}_{Δλ} ≅ {N}_{0} \times {10}^{- 0.4 {m}_{*}}$$

$${N}_{0} ≅ 1.46 \times {10}^{10}$$

$$ρ ( {y}_{pix} ) ≅ 1$$

$$κ ≅ 0.6$$

In an exemplary embodiment of the invention, at 0.3 AU distance, 0.4 m telescope diameter, quantum efficiency of 0.5, ten wavelength channels, n_{DC}=4 phot/s, and a 12^{th} magnitude star, the signal-to-noise ratio is approximately 9.1 for a 20×20 pixel silhouette image.

While the principles of the invention have been described herein, it is to be understood by those skilled in the art that this description is made only by way of example and not as a limitation as to the scope of the invention. Further embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An asteroid characterization and imaging system comprising:
at least one light collecting aperture positioned to collect intensity time history data; and
a data analysis unit configured to detect an occultation event and process said intensity time history data.

2. The system of claim 1 further comprising:
a data receiving station
wherein said data receiving station connectively communicates with said at least one light collecting aperture.

3. The system of claim 1 wherein said data analysis unit comprises:
a communications module;
a memory;
a central processing unit;
an imaging module; and
a characteristic calculation module
wherein said imaging module processes said intensity time history data to produce an image of said asteroid.

4. The system of claim 3 wherein said characteristic calculation module processes said intensity time history data to calculate asteroid characteristic data.

5. The system of claim 4 wherein said asteroid characteristic data comprises at least one of:
a velocity calculation of said asteroid;
a size of said asteroid;
a trajectory of said asteroid; and
a distance between said asteroid and said at least one light collecting aperture.

6. A method of detecting, characterizing and imaging a near-Earth celestial object comprising:
collecting intensity time history data by at least one light collecting aperture positioned to observe a star;
detecting a stellar occultation event;
recording said intensity time history data;
processing said intensity time history data;
predicting at least one of a set of object characteristics; and
imaging said near-Earth celestial object.

7. The method of claim 6 wherein said set of object characteristics comprises:
a velocity calculation of said near-Earth celestial object;
a size of said near-Earth celestial object;
a trajectory of said near-Earth celestial object; and
a distance between said near-Earth celestial object and said at least one light collecting aperture.

8. The method of claim 6 wherein said at least one light collecting aperture is positioned on a surface of Earth.

9. The method of claim 6 wherein said at least one light collecting aperture is positioned in a geosynchronous orbit of Earth.

10. The method of claim 6 wherein said imaging of said near-Earth celestial object further comprises:
inputting said intensity time history data into a shadow function;
applying a phase retrieval algorithm to said shadow function produce an unresolved image;
applying a silhouette function to said unresolved image to produce a silhouette image of said near-Earth object to produce a sharpened silhouette image.

11. The method of claim 10 further comprising applying a signal-to-noise ratio to said silhouette image.

12. The method of claim 6 wherein said at least one light collecting aperture is positioned with a plane normal to a line of sight to said star.

13. The method of claim 6 wherein said light collecting aperture continuously collects said intensity time history data.

14. The method of claim 6 wherein said light collecting aperture collect said intensity time history data at scheduled intervals.

15. The method of claim 6 wherein said intensity time history data is stored in a memory.

16. The method of claim 7 wherein said set of object characteristics is stored in a memory.

17. The method of claim 10 wherein said sharpened silhouette image is stored in a memory.

18. A method of imaging a near-Earth celestial object comprising:
collecting light intensity data as a function of time of a stellar occultation event;
processing said light intensity data as a function of time to generate a shadow function;
applying a phase retrieval algorithm to said shadow function to generate an unresolved image;
applying a silhouette function to said unresolved image.
